(19) United States
(12) Patent Application Publication
(10) Pub. No.: US 2018/0090856 A1
(43) Pub. Date: Mar. 29, 2018

(54) CLAMP ON BONDING JUMPER

(71) Applicant: Hubbell Incorporated, Shelton, CT (US)

(72) Inventor: Evan Ronald Martin, Merrimack, NH (US)

(21) Appl. No.: 15/678,548

(22) Filed: Aug. 16, 2017

Related U.S. Application Data
(60) Provisional application No. 62/398,729, filed on Sep. 23, 2016.

(51) Int. Cl. H01R 4/64; H02S 20/32; H02S 30/10; H01R 4/30; H01R 4/36

(52) U.S. Cl. CPC H01R 4/64; H02S 20/32; H01R 4/36; H01R 4/305; H02S 30/10

(57) ABSTRACT

A bonding jumper system includes a clamp capable of clamping a bonding jumper to a structure and a clamp bolt operationally associated with the clamp, the clamp bolt further including a ground post for attaching a ground cable.

### CROSS REFERENCE TO RELATED APPLICATIONS

The present application is based on and claims benefit from co-pending U.S. Provisional Application Ser. No. 62/398,729 filed Sep. 23, 2016 entitled “Clamp on Bonding Jumper” the entire contents of which are incorporated herein by reference.

### BACKGROUND

### Field

The present disclosure relates generally to bonding jumpers, and more particularly to clamp on bonding jumpers.

### Description of the Related Art

In recent years, the use of photovoltaic arrays to provide electrical power in commercial, residential, and other environments has become popular. Photovoltaic arrays are generally composed of a number of photovoltaic modules set within a metallic frame and a rail system that supports the photovoltaic modules. The rail system may be attached to a fixed support structure such as a roof or the ground or to a movable structure such as a solar tracker. When installing a photovoltaic array, a number of photovoltaic modules are assembled onto the rail system. The metallic frames of the individual photovoltaic modules, and the structural pieces, e.g., the rails, on which the modules are mounted are generally made out of aluminum. Depending upon the size of the photovoltaic array, the rail system may include multiple metallic rails coupled or connected together in a grid-like pattern. Although the metallic frames of the photovoltaic modules and the metallic rails are not intended to be energized, in order to avoid any appreciable potential difference between these metallic parts, bonding is generally performed. Bonding is a method by which all electrically conductive portions of a structure are effectively interconnected via a low impedance conductive path. For example, in the present example, the photovoltaic modules may be connected to each other and/or to the rail system utilizing bonding wires or straps. Attaching bonding wires or straps to the array generally involves drilling holes in the modules and rail and attaching the bonding wires or straps utilizing nuts and bolts. The photovoltaic modules and the rail system may also be connected to ground utilizing one or more ground wires or straps which may also involve drilling holes in the modules and/or rails.

### SUMMARY

The present disclosure provides a bonding jumper system including a clamp capable of clamping a bonding jumper to a structure and a clamp bolt operationally associated with the clamp, the clamp bolt further including a ground post for attaching a ground cable.

A bonding jumper system includes a bonding jumper cable, a pair of clamps, each clamp capable of clamping the bonding jumper to a structure and a pair of clamp bolts, each clamp bolt operationally associated with one of the pair of clamps, at least one of the pair of clamp bolts including a ground post for attaching a ground cable.

A bonding jumper clamp includes three parallel members extending from a connecting member, a bonding jumper permanently affixed between at least two of the three parallel members and a clamp bolt operationally associated with one of the three parallel members, the clamp bolt including a ground post for attaching a ground cable.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of a photovoltaic module attached to a rail of a solar tracking frame and bonded utilizing a bonding jumper system according to an illustrative embodiment of the present disclosure;

FIG. 2 is a perspective view of a bonding jumper system according to an illustrative embodiment of the present disclosure;

FIG. 3 is a view of a portion of the bonding jumper system illustrated in FIG. 1, taken along line 3-3, according to an illustrative embodiment of the present disclosure;

FIG. 4 is a perspective view of a bonding jumper clamp according to an illustrative embodiment of the present disclosure;

FIG. 5 is a perspective view of a clamping bolt according to an illustrative embodiment of the present disclosure; and

FIG. 6 is a perspective view of a clamping bolt according to another illustrative embodiment of the present disclosure.

### DETAILED DESCRIPTION

Illustrative embodiments of the present disclosure may be provided as improvements to bonding jumpers. For example, a bonding jumper may be attached to a structure utilizing clamps. The bonding jumper may also include a ground terminal to which a ground wire may be attached.

Illustrative embodiments of the present disclosure provide a bonding jumper system in which a bonding jumper includes at least one C-shaped clamp allowing the bonding jumper to be clamped to a structure. The C-shaped clamp may include a ground terminal allowing a ground wire to be attached to the bonding jumper system.

Illustrative embodiments of the present disclosure include at least one clamp permanently attached to a bonding jumper. The bonding jumper may be crimped between a pair of members forming a portion of the clamp. The bonding jumper may be a flat braided strap.

In certain illustrative embodiments described herein, the tightening bolt of the C-shaped clamp also serves as a ground terminal. According to an illustrative embodiment, the tightening bolt may be a SERVIT POST™ manufactured by Burndy LLC.

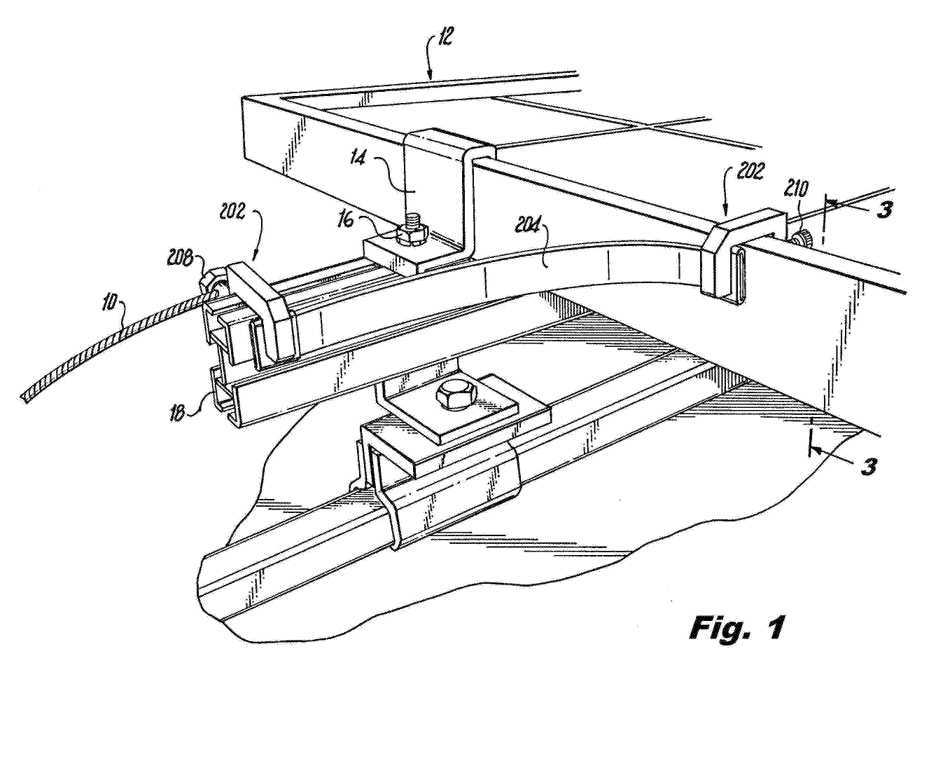

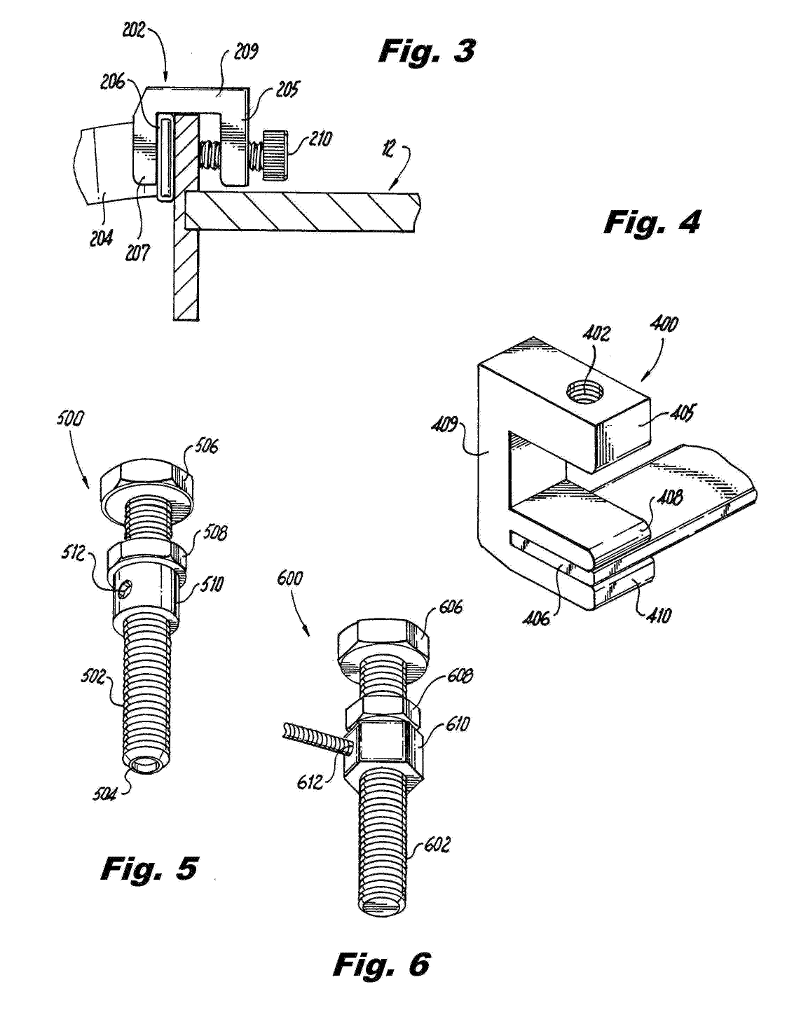

As shown in FIG. 1, a bracket system including brackets 14 and nuts and bolts 16 may be utilized to attach the frame 12 of a photovoltaic module to a rail 18 of a solar tracking frame. However, such bracket systems may not provide a sufficiently low impedance conductive path to avoid any appreciable potential difference between these metallic parts. Accordingly, a bonding jumper system according to an illustrative embodiment of the present disclosure may be used for bonding frame 12 of a photovoltaic module to rail 18 of the solar tracking frame. In the present embodiment, strap 204 is attached to rail 18 by positioning a distal end of strap 204 between clamp 202 and the rail 18 and tightening bolt 208. A ground wire 10 may be attached to bolt 208 utilizing, for example, one of the appropriate clamping bolts to be described in the present disclosure. As shown in greater detail in FIG. 3, the other end of strap 204 is attached to frame 12 by positioning strap 204 (and cap 206) between member 207 of clamp 202 and frame 12 and tightening bolt 210 against frame 12. The bonding jumper systems as described herein provide a reliable low impedance conductive path for electrically bonding the metallic parts.

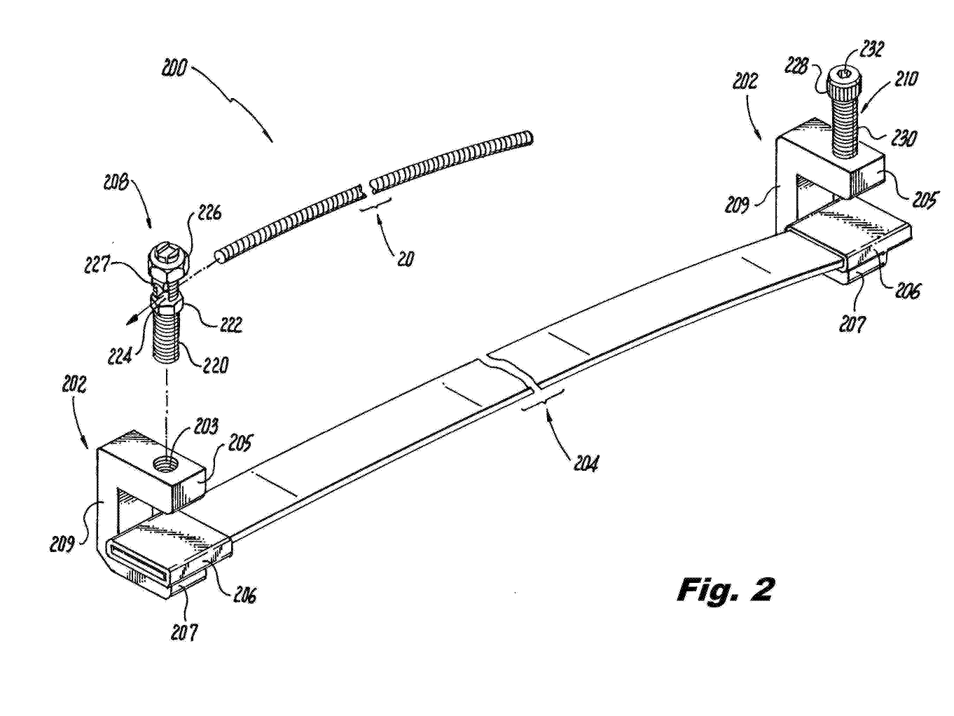

A clamp on bonding jumper system according to an embodiment of the present disclosure will be described in more detail below by reference to FIG. 2 and is referred to generally as bonding jumper system 200. Bonding jumper system 200 includes a bonding cable or strap 204. According to an illustrative embodiment of the present disclosure, bonding cable or strap 204 is a flat braided strap which may be, for example, aluminum, brass, copper, steel, etc. The ends of strap 204 may include metal caps 206 which may also be, for example, aluminum, brass, copper, steel, etc. Caps 206 may be attached to strap 204 in any suitable manner including, for example, by crimping, welding, soldering, etc. According to another illustrative embodiment of the present disclosure, caps 206 may be positioned on the ends of strap 204 just prior to them being positioned and clamped in place, with clamping bolt 208 or clamping bolt 210 providing the force for maintaining the strap 204 and cap 206 in position. Strap 204 may vary in length depending on a particular application. For example, strap 204 may be provided in 6″, 1′, 3′, 5′, 6′ lengths or any other suitable length. Bonding jumper system 200 also includes C-shaped clamps 202, formed by substantially parallel members 205 and 207 separated by connecting member 209. As shown, parallel member 205 includes a threaded hole 203 for receiving a clamping bolt 208, 210. The C-shaped clamps 202 may be provided in various sizes. For example, the distance between parallel members 205, 207 may vary depending on a particular application. That is, if the C-shaped clamp 202 is to be used to clamp a relatively thin frame, the distance between parallel members 205, 207 may be a first distance. If the C-shaped claim 202 is to be used to clamp a relatively thick rail, the distance between members 205, 207 may be greater than the first distance. Clamping bolts 208 and 210 may be the same or different types of bolt. For example, as shown in FIG. 2, bolt 208 may be a SERVIT POST™ by Burndy LLC. The SERVIT POST™ includes a threaded post 220, fixed nut 222 and slot 224. Movable wire clamping member 227 moves up and down in slot 224 by rotation of nut 226 in the counterclockwise or clockwise direction. Utilizing the SERVIT POST™, a ground cable 20 may be attached to the bonding jumper system 200. For example, fixed nut 222 is utilized to tighten bolt 208 to clamp 202. A ground cable 20 is then positioned in the SERVIT POST™ below clamping member 227. Nut 226 is rotated in the clockwise direction to urge clamping member 227 down against ground cable 20 securing it in position. Bolt 210 may be a basic clamping bolt having a threaded post 230 and head portion 228. Head portion 228 may be any suitable type of head allowing the end user to tighten the bolt 210. In the exemplary embodiment shown in FIG. 2, head portion 228 of bolt 210 includes a hexagonal socket 232 for receiving a hexagonal wrench. C-shaped clamps 202 may be, for example, aluminum, brass, copper, steel, etc. Strap 204 may be positioned in clamps 202 just prior to the clamp being attached to a structure. Alternatively, straps 204 may be permanently attached to clamps 202 by welding, soldering, crimping, etc.

A clamp according to another illustrative embodiment of the present disclosure is shown in FIG. 4. According to this embodiment, a substantially E-shaped clamp 400 is formed by substantially parallel members 405, 408 and 410 separated by connecting member 409. As shown, parallel member 405 includes a threaded hole 402 for receiving a clamping bolt (not shown). Depending on a particular application, any suitable type of clamping bolt may be utilized, including those described herein. A braided bonding cable or strap 406 is positioned and crimped between parallel members 408 and 410 to provide a permanent connection between strap 406 and clamp 400. The opposite end of strap 406 may have a similar clamp 400 crimped and permanently attached thereto. Alternatively, the opposite end of strap 406 may be attached to a structure utilizing a removable C-shaped clamp 202 such as that described above with respect to FIGS. 1-3. Clamp 400 and strap 406 may be, for example, aluminum, brass, copper, steel, etc.

According to various embodiments of the present disclosure, other types of clamp bolts may be utilized for clamping the clamps to a structure and providing a ground post for attaching a ground wire. A clamp bolt according to another embodiment of the present disclosure is shown in FIG. 5 and is referred to generally as jack screw bolt 500. Jack screw bolt 500 includes a threaded shaft 502. According to an embodiment of the present disclosure, threaded shaft 502 includes a “cupped” distal end 504, which allows bolt 500 to bite into a surface of the structure, cutting through surface coatings naturally occurring (e.g., oxidation) or intentionally added (e.g., anodized) to the surface of the structure providing electrical continuity to the structure. It should be noted that the “cupped” shaped distal end of bolt 500 may be provided on any of the clamp bolts described herein. Threaded shaft 502 is integral with hexagonal head 506. A sliding member 510 has an inner dimension such that it is capable of sliding up and down on threaded shaft 502. A hole 512 passes through a side of sliding member 510 and through threaded shaft 502 and a nut 508 is provided for tightening sliding member 510. After bolt 500 is secured to one of the clamps described above, a ground wire (not shown) is passed through holes 512 in sliding member 510 and shaft 502. Nut 508 is then rotated which urges sliding member 510 against the wire securing the wire in position.

A clamp bolt according to another embodiment of the present disclosure is shown in FIG. 6 and is referred to generally as screw bolt 600. Screw bolt 600 includes a threaded shaft 602 which is integral with hexagonal head 606. A nut 610 includes an integral ground wire or cable 612 extending therefrom. Cable 612 may be welded or otherwise permanently attached to nut 610. Nut 608 is threaded onto threaded shaft 602. Nut 610 can be moved up and down on shaft 602 by rotating head 606 in the clockwise or counterclockwise directions as desired. When appropriately positioned, nut 608 is rotated until it abuts nut 610 locking it in position.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A bonding jumper system comprising:
a clamp capable of clamping a bonding jumper to a structure; and
a clamp bolt operationally associated with the clamp, the clamp bolt further comprising a ground post for attaching a ground cable.

2. The bonding jumper system as recited in claim 1, wherein the clamp comprises a substantially C-shaped clamp.

3. The bonding jumper system as recited in claim 1, wherein the clamp comprises a substantially E-shaped clamp.

4. The bonding jumper system as recited in claim 3, further comprising a bonding jumper, wherein the bonding jumper is permanently attached to the clamp.

5. The bonding jumper system as recited in claim 4, wherein the bonding jumper comprises a braided cable.

6. The bonding jumper system as recited in claim 5, wherein the braided cable is flat.

7. The bonding jumper system as recited in claim 1, wherein the clamp bolt comprises a SERVIT POST™.

8. The bonding jumper system as recited in claim 1, wherein the clamp bolt comprises a jack screw bolt.

9. A bonding jumper system comprising:
a bonding jumper cable;
a pair of clamps, each clamp capable of clamping the bonding jumper to a structure; and
a pair of clamp bolts, each clamp bolt operationally associated with one of the pair of clamps, at least one of the pair of clamp bolts including a ground post for attaching a ground cable.

10. The bonding jumper system as recited in claim 9, wherein the bonding jumper cable comprises a flat cable.

11. The bonding jumper system as recited in claim 10, wherein the flat cable comprises a braided flat cable.

12. The bonding jumper system as recited in claim 9, wherein at least one of the pair of clamps comprises a substantially C-shaped clamp.

13. The bonding jumper system as recited in claim 9, wherein at least one of the pair of clamps comprises a substantially E-shaped clamp.

14. The bonding jumper system as recited in claim 13, wherein the bonding jumper cable is permanently attached to the E-shaped clamp.

15. The bonding jumper system as recited in claim 14, wherein the bonding jumper cable is crimped to the E-shaped clamp.

16. A bonding jumper clamp comprising:
three parallel members extending from a connecting member;
a bonding jumper permanently affixed between at least two of the three parallel members; and
a clamp bolt operationally associated with one of the three parallel members, the clamp bolt including a ground post for attaching a ground cable.

17. The bonding jumper clamp as recited in claim 16, wherein the bonding jumper comprises a flat cable.

18. The bonding jumper clamp as recited in claim 17, wherein the flat cable comprises a braided flat cable.
